(19) United States
(12) Patent Application Publication
(10) Pub. No.: US 2017/0061094 A1
(43) Pub. Date: Mar. 2, 2017

(54) METHOD OF IMPROVING MEDICATION ADHERENCE

(71) Applicant: Arvind Movva, Moline, IL (US)

(72) Inventor: Arvind Movva, Moline, IL (US)

(21) Appl. No.: 15/248,511

(22) Filed: Aug. 26, 2016

Related U.S. Application Data
(60) Provisional application No. 62/209,996, filed on Aug. 26, 2015.

(51) Int. Cl. G06F 19/00

(52) U.S. Cl. CPC G06F 19/3456

(57) ABSTRACT

The present invention includes methods and system for improving a medication adherence rate of a patients including constructing a medication list for the patient and notifying the patient of each dosing event. A response or non-response of the patient to the notification is recorded and a medication adherence rate for each patient is calculated and displayed to the patient and/or medical professional.

### CLAIM OF PRIORITY

The present application claims the benefit of U.S. provisional application No. 62/209,996, filed on Aug. 26, 2015, which is incorporated by reference.

### FIELD OF THE INVENTION

The present invention relates to improving the medication adherence rate of a patient, and more particularly, to scoring a patient's medication adherence and providing feedback to encourage a higher rate of medication adherence.

### BACKGROUND OF THE INVENTION

Medications are effective at controlling and preventing long-term health consequences, which in turn reduces the morbidity, mortality, and fiscal costs associated with chronic diseases. But the effectiveness is correlated with the adherence of the patient to the dosing regimen for the medication. That is, does the patient take the correct dosage at the correct time. Large peer-reviewed studies show medication adherence by patients is a paltry 50%. This lack of adherence does not allow the medications to have their intended effect that the medical professional had planned, which leads to poor outcomes along with higher costs to the system as a whole.

Given the physical and temporal distance between medical professional and patient, the medical professionals cannot know the actual adherence rate of each of their patients. Patients are known to overestimate their adherence rates and underestimate their mistakes. This can lead uninformed decision making by the medical professionals. For example, a medication that is perceived as not being effective because of poor medication adherence can be unnecessarily increased in dosage.

Tracking medication adherence requires a complete and accurate list of all current and past medications that a patient is taking as well as the dosage and timely dosing. For patients with a limited number of medications, pen and paper may be effective, but it relies on the patient to note missed dosages and patients that forgot to take a dose are unlikely to remember to note the missed dose. For patients with more medications, pen and paper will never be effective because of the shear number of medications involved as well as the various electronic and paper formats that medical professionals use to prescribe medications. Moreover, even computerized systems do not track missed dosages. So, even if medication data is available, medication adherence data is nearly impossible to track for even a single patient, much less for a medical professional's entire list of patients.

### SUMMARY OF THE INVENTION

The present invention is method and systems for improving medication adherence of patients or populations of patients including: 1) constructing a list of medications for each patient; 2) notifying the patient to take a particular medication in a particular dosage amount at a particular time, 3) recording a response or non-response by the patient to the notification; 4) calculating a medication adherence rate based on the cumulative responses of a patient over time. The method may further include displaying the calculated medication adherence rate to the patient (including caregivers) and/or medical professionals. Additional embodiments include providing the medications to the patients in dosing packets. Yet another embodiment includes identifying a patient population and applying the disclosed medication adherence improvement methods to the population to improve a health outcome for the population.

### BRIEF DESCRIPTION OF THE DRAWINGS

FIG. 1 shows a housing to hold a plurality of dosing packets to insure one at a time dispensing of the packets to the patient.

FIG. 2 shows an exemplary graphic of a medication adherence rate displayed for a patient.

### DETAILED DESCRIPTION

As used herein, the term patient include the person who will be taking the medication as well as caregivers, those who help the patient in taking their medications, as well as interested parties, such as remotely located family members or friends of the patient, caregivers, or medical professionals who wish to be apprised on the patient's medication adherence rate.

As used herein, the term medical professional means doctors, nurse practioners, or anyone authorized to make medication decisions for the patient. Medical professional also includes employees and agents of healthcare providers (e.g. hospitals, nursing facilities, hospice, etc.) as well as health insurance providers.

The present invention includes methods and systems for improving medication adherence including: 1) constructing a list of medications for each patient; 2) notifying the patient of a dosing event; that is, to take a particular medication in a particular dosage amount at a particular dosing time, 3) recording a response or non-response by the patient to the notification; 4) calculating a medication adherence rate based on the cumulative responses of a patient over time; and 5) displaying a medication adherence rate to the patient.

Constructing the list of medications is done through a centralized pharmacy, such that all of a patient's medications, current and past, are contained in a computerized database. This list preferably includes only medications dispensed to the patient.

The medication list preferably includes, for each medication, the identity of the medication by generic and/or brand name, the dosing frequency, the dosing times, the dosage amounts, a depiction of the medication or applicator (e.g. a picture of the medication in pill form), as well as dosing instructions (e.g. “until gone” or “take with food” or “for topical use only”) and applicator instructions (e.g. “remove backing and apply to skin behind the ear”). The medication list is stored in a secured computer database.

The medication list may be constructed by the patient, or with authorization from the patient. For example, a caregiver may add vitamins or sunscreen to the medication list. In the alternative, the patient may authorize a third party to construct the medication list on their behalf, e.g. through a health care power of attorney, through a primary care physician, or merely by selecting a single pharmacy to fill all a patient's prescriptions.

The construction of medication list may also include checks to make sure the medication list is in compliance with the various laws, rules, and regulations governing dispensing of medications. Likewise, the medication list may be checked to insure adverse drug interactions are avoided and to insure that only medications covered by the patient's health insurance are included on the medication list.

While the medication list is preferably constructed and stored at a central location that is remote from the patient's and the medical professional's location, the medication list may nevertheless be constructed and stored locally on the patient's or medical professional's device for later transmission to the central location and storage there.

Medication means both prescription and non-prescriptions medicines, as well as dietary supplements such vitamins, minerals, nutraceuticals, or the like, that maybe beneficial for a patient to take in discrete amounts and/or on a schedule. Medication is not defined by the delivery method and may include items delivered by ingestion, by inhalation, or intravenously, transdermally, and/or via one or more mucosal membranes, etc.

Dosing event means the activity during which a medication is taken or administered to a patient and in which a particular medication, in a particular dosage amount, and at a particular dosing time, is taken or administered to a patient.

Dosing frequency may include the number of doses to be taken in a given time period, e.g. twice a day or once a week. Dosing time may include a time, a point in a day, or an associated activity when the patient is to take a medication. For example, dosing time may mean a specific time, 8 am, or a point in the day, e.g. morning. An example of an associated activity may be ‘before bed’ or ‘with dinner’.

Dosage amount means a discrete volume, weight, or unit of medication that may or may not be pre-segregated for the patient by the pharmacy. For example, dosage amounts may be pre-segregated in the form of tablets, single use injectors, single ampules, or single use transdermal patches. On the other hand, dosage amounts may be segregated by the patient at the time of dosing such insulin, which is drawn from a vial. The dosage amount may be presented as a specific volume or weight (e.g. 25 mg) and/or a specific number of units (e.g. 2 tablets or one lozenge).

Typically, a patient will utilize a single pharmacy to fill of the patients prescriptions in that all of the patient's health care providers will send prescriptions to a single pharmacy. Moreover, the pharmacy preferably provides the medications delivered to the patient. Medications are preferably delivered to the patient's residence by mail or courier, eliminating the need for the patient to travel to the pharmacy.

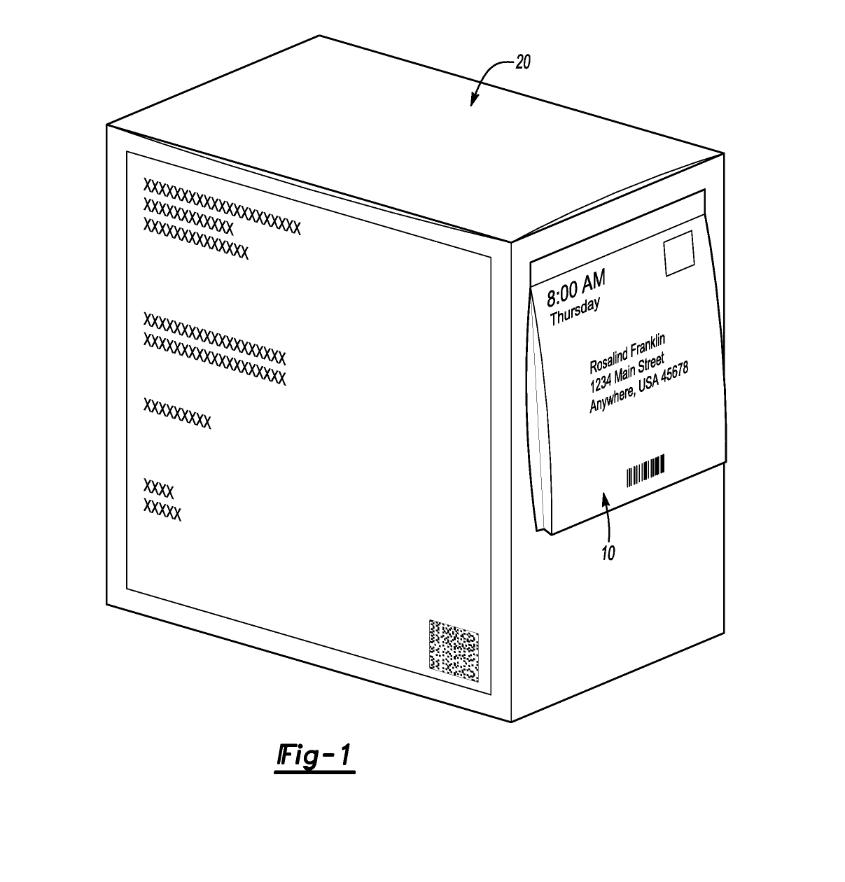

In one embodiment, once the medication list constructed, the medications are provided, through the pharmacy, to the patient in dosing packets so that medications to be taken at the same time are packaged together in a single dosing packet, as seen at reference numeral 10 in FIG. 1. The dosing packets preferably made of plastic or plastic lined paper that is easy to open but yet sufficient strong to contain and protect the medications from adverse conditions prior to use. Perforations may be used to ease opening of the dosing packets.

The dosing packets are preferably provided in a time sequence to encourage the patient to take the medications in a certain order, thus improving the medication adherence rate, as discussed below. The dosing packets are placed in sequence generally by dosing time such that a ‘with dinner’ packet will be before ‘at bed time.’ In situations where a significant number of medications are to be taken at one time, a plurality of dosing packets may be used showing the same dosing time and numbered as “1 of 2” and “2 of 2”, for example. Furthermore, for medications that are too large to fit within a dosing packet (e.g. because it includes a syringe), the dosing packet may include additional instructions for the patient to take medications that are not within that particular dosing packet. Such instructions may be located on the packet or inside the packet.

In one embodiment, the time sequenced packaging includes dosing packets that are on a strip or roll, such that the first dosing packet is at one end and the last dosing packet is at the other end. In this embodiment, the dosing packets are separated by perforations to ease dispensing of one dosing packet while maintaining the remainder of the dosing packets on the strip or roll. In the rolled embodiment, the packets are rolled onto an axle (or themselves) with the last dosing packet at the center of the roll and the first dosing packet at the circumference of the roll. The patient then removes each dosing packet in order from the roll in time sequence order. In addition to encouraging the patient to take medications in a desired order, this also provides a visual cue about which dosing packet is to be taken next; that is, the packet at the end of the roll is the next packet to be taken by the patient.

In one embodiment, the roll of dosing packets is held within an outer housing that dispenses the dosing packets in a one-at-a-time manner, as seen at reference numeral 20 in FIG. 1.

The packaging (that is, the dosing packets and/or the housing) may include information from the medication list, such as the medications, dosages, and dosing time of the dosing event, as well patient identifying information, all of which may be textual or graphical. The packaging may also include text or graphics that provides further instructions to the patient regarding the properly dosing event. For example, if several rolls of packets are provided at one time, the housing may be number ordered or color coded to insure the dosing packets in the first housing are used first, etc. Also, dosing packets to be used within a given time frame can be sequentially numbered (e.g. each of the packets for a dosing event in a given day will be incremented over the previous dosing event). Likewise, a graphic of a sun, moon, night sky, or the like can be used on the dosing packets to indicate to the patient as to the proper time of day for the dosing event of the dosing packet having the graphic.

The packaging may also include a bar code identifying the dosing event, the patient, etc. as bar codes may be used by the pharmacy to conduct quality control to insure the proper medications are provided to the patient. Likewise, bar codes may be utilized by patients or medical professionals to insure that the proper packet is being dispensed at the proper dosing event. As discussed below, the barcode may be used by the patient to confirm or acknowledge that the medication was taken. In one embodiment, the barcode is located on the inside surface of the dosing packet to insure that barcode is only accessible once the packet has been opened.

After the medication list is constructed, the patient may be notified so that the patient can check the completeness and accuracy of the medication list. Likewise, medical professionals may also be notified to check the accuracy and completeness of the medication list. Any party may request changes be made to the medication list, with certain changes requiring approval, such as approval by a medical professional.

With the medication list finalized and the medications obtained by, or provided to, the patient, a patient will be notified of each dosing event. That is, which dosing packet to dispense and take, which medication to take, how much of the medication to take, and the dosing time for each medication or packet. The notification of each dosing event preferably is in the form of a push notification to a patient's mobile device that comes from a central location (such as, a computer operated by the pharmacy). The mobile device will preferentially be pre-loaded with an application to receive the notification. The notification may also be made through a phone call to the patient's mobile device or through a SMS/MMS text message to the patient mobile device. Less preferred, by still viable, are notifications made by email to the patient or through other two way communication systems (e.g. Life Alert®).

The content of the notification will include at least two optional responses from the patient: ‘taken’ and ‘skipped.’ The first indicating a positive response and that the patient has acknowledged dosing the packet or medication in the dosage amount at the dosing time. The second indicating a negative response and that the patient has acknowledged not dosing the medication in the dosage amount at the dosing time.

The content of the notification may include a third option; that is, to take a picture of the dosing packet or to scan a bar code on the dosing packet. Such a picture or scan could be treated as a positive response.

In one embodiment, a patient could pre-empt a dosing event notification by photographing the dosing packet or scanning the bar code. In such situation, the notification would be in the form of confirmation that a positive response had been received from the patient on that particular dosing event.

While discussed in terms of notification going to the patients and patients providing responses, it contemplated that the notification could be provided to any third party responsible for a patient's medications, such caregivers and/or medical professionals. And that such responsible third parties could also provide the response as ‘given’ or ‘skipped.’

Once the notification has been given to the patient, the positive, negative or non-response of the patient is recorded. The recordation may initially take place on the mobile device with the information subsequently transmitted to the central location and stored there. For example, the notification may include a dialog box with two buttons that are able to be touched or clicked by the patient; e.g. a ‘taken’ button and a ‘skipped’ button with the response recorded on the patient's mobile device. Likewise for email notifications, the message may include a link for ‘taken’ and a link for ‘skipped,’ with the response recorded on the patient's mobile device or computer. The response may be stored on the mobile device and then transmitted to the central location immediately or at a later time, where it is also stored.

In the alternative, the recordation may take place only at the central location. For example, when the notification is a phone call, the response (positive or negative) may be the pushing or clicking of a button; e.g. push ‘1’ to indicate that a medication was taken or push ‘2’ to indicate that a medication was skipped. Similarly for a text message notification; sending a reply text with ‘1’ to indicate that a medication was taken or reply with ‘2’ to indicate that a medication was skipped. For phone calls and other two way communications, the response may be verbal and recorded by the caller, whether human or computerized.

Non-responses can be recorded when a patient fails to provide either a positive or negative response. For example, a phone call that goes to voice mail can be immediately recorded as a non-response. In the alternative, a phone call that is not returned by the patient within a set time period may be recorded as a non-response. Similarly, a text message or email reply that is not received within a set time period may be recorded as a non-response. Failure to click any button on the dialog box or link within a set time period may be recorded as a non-response.

The non-response time period may be set for each patient, for each dosing packet, for each medication, for each dosing time, or for each dosing event. For example, some patients may have more flexibility about when they take their medication because of the nature of their condition. Some medications may require high adherence for maximum effectiveness. For some dosing times noted as ‘before bed’, the non-response time may be longer than dosing times noted as ‘1 pm’. In general, the non-response time is anywhere from 5 to 60 minutes.

Moreover, positive, negative, and non-responses may be given a value based on the time period between the defined dosing time and the response time. For example, a positive response within 1 minute of notification may be given a higher relative value than a positive response 5 minutes after the notification. Furthermore, a negative response within 1 minute of notification may be given a lower relative value than a negative response 5 minutes after notification, as a quick negative response is preferred over a slow negative response.

Once the positive, negative, or non-response to a notification is recorded, the method includes calculating a medication adherence rate. The medication adherence rate is a score to indicate the number of medications that are correctly taken at the correct dosing times over a given time period. The higher the medication adherence rate or score, the more accurately and more consistently the patient is taking their medications. While the scale is arbitrary, a commonly understood scale should be used such as 1-10 or 1-100.

The medication adherence rate may be calculated as a straight percentage of positive responses compared to the entire number of dosing events. In this embodiment, the medication adherence rate is a score that is the same as the percentage of medication taken correctly.

In the alternative, the medication adherence rate may be calculated as a weighted percentage of the positive responses, incorporating the values of the positive and negative responses, compared to the entire number of dosing events. For example, a patient with many quick positive responses will have a higher medication adherence rate than a patient with only a few quick positive responses. In this embodiment, the medication adherence rate is a score that varies for the percentage of medication taken correctly.

In one example, positive responses within 1 minute of the notification may be multiplied by 1.5 to increase their value, positive responses between 5 and 10 minutes after notification may be multiplied by 0.5 to decrease their value. In this scenario, positive responses between 1 and 5 minutes are unweighted (that is, multiplied by 1.0), while a positive response after 10 minutes is counted as a negative response or non-response (that is, multiplied by zero or otherwise excluded from the number of positive responses).

In addition, the existence of a plurality of negative or non-responses may be used to apply a reducing factor to the medication adherence rate; that is increase the detriment of the negative or non-responses to the medication adherence rate. For example, after several missed dosing events in a day or for a particular medication, the medication adherence rate may be reduced to indicate that the patient is not consistently adhering to the medication protocol. The size of the reducing factor will typically increase as the number of negative responses or non-responses accumulate.

The reducing factor may be a straight reduction in the medication adherence rate (e.g. a reduction of 5% for every 3 missed dosing events in a day). In the alternative, the reducing factor may be applied to reduce the value of the positive responses in a given day. For example, instead of positive responses being unweighted, positive response may be weighted by a factor of 0.9 on days in which a patient has 3 missed doing events. The reducing factor may also be applied to enlarge the detriment of the negative responses on the medication adherence rate in a given day. For example, instead of a negative responses being counted as zero, negative responses may be weighted by a negative factor (such as, −1), thus meaning the negative or non-responses are result in a reduction of the medication adherence rate.

Separate medication adherence rates can be calculated for particular packets, particular medications, particular dosing times, particular delivery methods, particular time periods, etc. The separate medication adherence rates can be calculated based on patient or medical professional selectable criteria.

While the medical adherence rates are preferably calculated and stored at a central location that is remote from the patient's and the medical professional's location, they may nevertheless be calculated and stored locally on the patient's or medical professional's device for later display on the device and/or for transmission to the central location and storage there.

The method also includes steps related to monitoring a patient's medication adherence rate over time by comparing an initial medication adherence rate with a second medication adherence rate at a subsequent time to generate a result. The initial medication adherence rate may be a known or estimated medication adherence rate established through previous monitoring of a patient's medication adherence rate or through self-assessment by a patient, caregiver, etc. of a patient's previous medication adherence rate. In the alternative, an initial medication adherence rate may be assigned to a patient based on demographic or other factors. For example, it may be that younger women demonstrate, as a population, higher medication adherence rates than older men. Or, it may be the case that patients with caregivers demonstrate a higher medication adherence rates, as a population, compared to patients without caregivers. In another embodiment, the initial medication adherence rate is arbitrarily assigned as an aspirational medication adherence rate for the patient so as to encourage the patient to improve their rate.

The results of the comparison of medication adherence rates over time can be used to provide alerts to patients and/or medical professionals. Such alerts may be notifications, as discussed elsewhere, that a patient's medication adherence rate has fallen off significantly within a time period, so as to instigate improvement or follow up by the alerted person or entity. Further, the alerts may be in form of displays, as discussed elsewhere. In addition, the results of the comparisons can be used to provide alerts in the form of positive reinforcement when a patient's medication adherence rate has improved, such as through notifications and displays.

The results of the comparison of separate medication adherence rates can be used to modify a patient's medication list including adjusting medications, dosage frequency, dosage times, and/or dosing amounts. For example, if a patient's medication adherence rate for dosing events in the morning is below their medication adherence rate for dosing events in the afternoon, then the additional steps can be taken to improve the patient's morning medication adherence rate such as additional notifications like a phone call in addition to a push notification. In another example, if a patient's medication adherence rate for tablet medications is poor compared to transdermal medications, then the tablet medication may be switched for a transdermal formulation.

In another embodiment, dosing times can be adjusted to more accurately reflect the patient's lifestyle, e.g. a third or second shift worker will need a different dosing event scheduling then a day shift worker which may only become apparent from monitoring the medication adherence rate for the patient. That is, a poor medication adherence rate during the day, but an excellent medication adherence rate in the evening hours may indicate that a change in dosing schedule is needed.

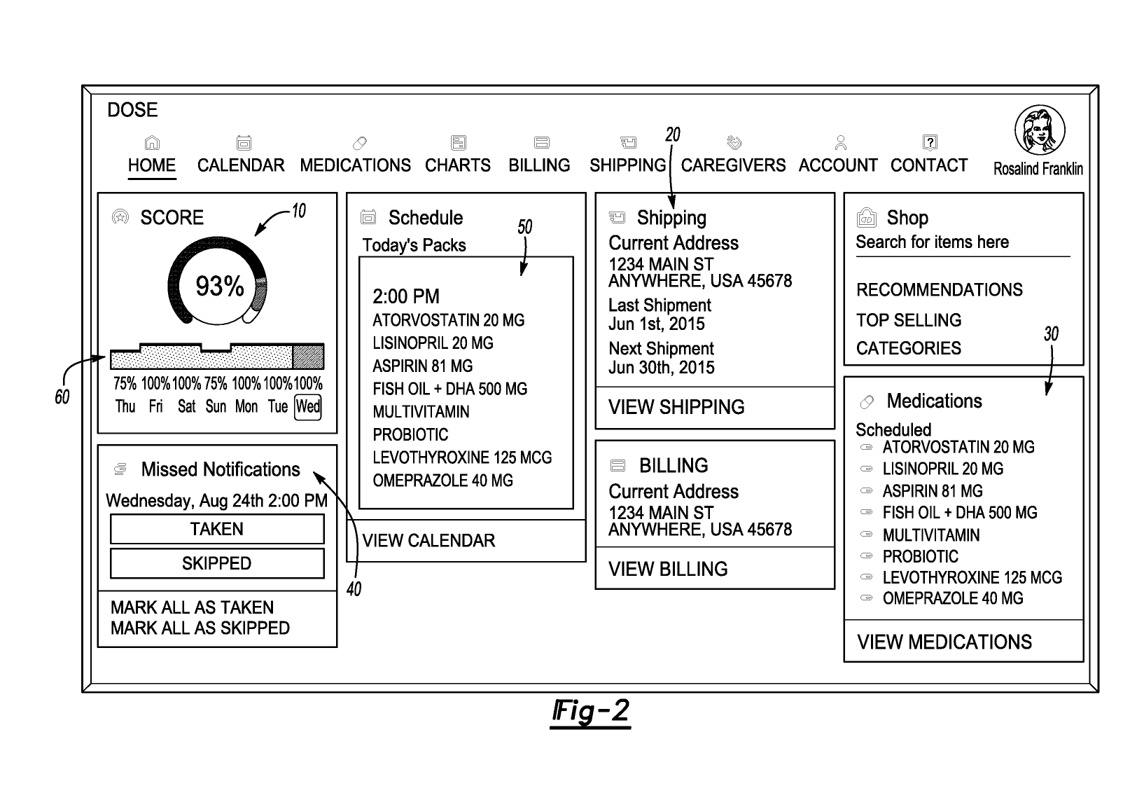

The method includes displaying the calculated medication adherence rate or score to the patient (including caregivers) and/or medical professionals. The display may be on the same mobile device that the patient receives their dosing notifications on and/or on a separate computer. The display may be part of limited access website, as part of an email message to one or more addresses, as part of a text message to one or more phone numbers, as part of a push notification to the patient's mobile device, or the like. The display may include only text, only graphics or combinations thereof. In one preferred embodiment, the medication adherence rate is displayed graphically in a meter with colors or shading indicating the different medication adherences rates, as seen at reference numeral 10 in FIG. 2. In another embodiment, the medication adherence rate of a patient at various points in time is displayed as a chart to illustrate trends the patient's medication adherence rate.

As seen in FIG. 2, the display of the medication adherence rate 10 may be combined with other text and graphic information for the patient such as biographical information 20, the medication list 30, notifications 40, dosing events 50, and medication adherence rates over time 60, for example.

The methods of the present invention also include improving the health outcome of a patient by improving the patient's medication adherence rate over time. That is, from an initial medication adherence rate for a patient, the patient's health is improved by increasing the patient's medication adherence rate. For example, regarding diabetes, the long term complications of diabetes (e.g. diabetic retinopathy) can be minimized by improving consistency of regulation of blood sugar, which in term may be improved by better adherence to a patient's medication protocol; i.e. a higher medication adherence rate.

The methods and systems of the present invention may also be used to improve the health outcomes of a population of patients. By selecting one or more grouping of patients to utilize the methods and systems described, the health an entire population of patients may be improved by collectively improving the population's medication adherence rate.

For example, a population of patients may be a group of patients who are similar in age, gender, genetic makeup, geographic location of birth, residence, or employment, height, weight, SMI, current health status (e.g. fighting an active bacterial infection), previous health status (e.g. cancer survivor), identity of health care provide (e.g. all patients of a doctor or hospital), identity of healthcare insurance provider, and combinations and sub-combinations of these groupings.

Moreover, individual conditions or groups of conditions can be targeted for improvement within a population of patients as well as the overall health a population.

In this embodiment, the method is applied to each patient individually (e.g. a medication list is constructed for each of a plurality of patients, etc.). And, in addition to displaying each patient's medication adherence rate to that patient, the group wide medication adherence rate is calculated and may be displayed to all members of the population and/or medical professionals responsible for the health care of one or more patients in the population. This can be used as a method of encouraging each member to improve their own medication adherence rate in order to boost the population wide medication adherence rate.

In addition to the methods described above, the present invention also includes systems for carrying out the steps of the method. The system includes a computer (including virtual machines) which is at a central location that is remotely accessible from a variety of devices using a variety of networks (e.g. WAN, LAN, or PSTN) and a variety protocols (e.g. TCP). The computer includes devices needed to carry out its functions such as memory, storage, CPUs, GPUs, networking devices, input devices, displays, etc. The system, as part of the computer or separately, also includes devices to transmit and receive information from the central location to the patient's device.

The system also includes software that is appropriately programmed to carry out the functionality of the described methods. For example, the computer includes software: to facilitate the construction of the medication list; to store the medication list; to prepare and transmit the dosing event notifications; to receive, record, and store patient responses to the dosing event notifications; to calculate, store, and compare the medication adherence rates (both initial and subsequent rates) for patients and populations; and to transmit and/or display medication adherence rates to patients, populations, and medical professionals.

It will be further appreciated that functions or structures of a plurality of components or steps may be combined into a single component or step, or the functions or structures of one-step or component may be split among plural steps or components. The present invention contemplates all of these combinations. Unless stated otherwise, dimensions and geometries of the various structures depicted herein are not intended to be restrictive of the invention, and other dimensions or geometries are possible. Plural structural components or steps can be provided by a single integrated structure or step. Alternatively, a single integrated structure or step might be divided into separate plural components or steps. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention. The present invention also encompasses intermediate and end products resulting from the practice of the methods herein. The use of “comprising” or “including” also contemplates embodiments that “consist essentially of” or “consist of” the recited feature. The use of “rate” and “score” in the context of medication adherence are used interchangeably.

The explanations and illustrations presented herein are intended to acquaint others skilled in the art with the invention, its principles, and its practical application. Those skilled in the art may adapt and apply the invention in its numerous forms, as may be best suited to the requirements of a particular use. Accordingly, the specific embodiments of the present invention as set forth are not intended as being exhaustive or limiting of the invention. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes.

What is claimed is:

1. A method for improving a medication adherence rate in one or more patients, comprising:
constructing a medication list for one or more patients, wherein the medication list comprises, for each medication, one or more of: identity of the medication, dosing frequency, dosing times, dosage amounts, medication and/or applicator depictions, dosing instructions and/or applicator instructions;
notifying the one or more patients of each dosing event including the medication and dosing amount to be taken by the patient, wherein the notifying comprises sending a notification from a central location and the notification includes at least one optional response from the patient, wherein the response indicates that the patient has taken the medication of the dosing event as notified;
recording, at the central location, a response or non-response from the one or more patients for each dosing event;
calculating, at the central location, at least one medication adherence rate for each of the one or more patients; and
transmitting to each of the one or more patients and/or one or more medical professionals, a text or graphic display of the at least one medication adherence rate.

2. The method of claim 1 wherein the calculating step comprises calculating the at least one medical adherence rate as the percentage of the number of positive responses recorded compared to the total number of dosing events.

3. The method of claim 1 wherein the calculating step comprising calculating the at least one medication adherence rate as weighted percentage of positive responses recorded compared to the total number of dosing events.

4. The method of claim 1 wherein the push notification comprises at least two optional responses from the patient or medical professional, a first optional response indicating that the patient has taken the medication of the dosing event as notified and a second optional response indicating that the patient has skipped the medication of the dosing event.

5. The method of claim 1 further comprising providing a plurality of dosing packets to the one or more patients, wherein the dosing packets contain one or more medications to be taken at one dosing event by each of the patients.

6. The method of claim 4 wherein the plurality of dosing packets are connected together in a time sequence.

7. The method of claim 5 wherein the connected dosing packets are rolled and held in an outer housing.

8. The method of claim 1 further comprising:
storing an initial medication adherence rate for the one or more patients; and
generating a result by comparing the initial medication adherence to the calculated medication rate for each of the one or more patients.

9. The method of claim 8 further comprising monitoring the medication adherence rate for each of the one or more patients over time by iteratively storing medication adherence rate for each patient and generating a result.

10. The method of claim 9 further comprising:
providing an alert based on the result to each of the one or more patients and/or to one or more medical professionals; or
modifying the medication list for one or more of the patients by adjusting one or more of identity of medications, dosing frequency, dosing times, dosage amounts, medication depictions, dosing instructions and/or applicator instructions.

11. The method of claim 10 wherein the providing step comprises:
notifying one or more of the patients of a change in their medication adherence rate; or
displaying, for one or more of the patients and/or medical professionals, a change in medication adherence rate for each of the one or more patients.

12. The method of claim 1 further comprising:
grouping a plurality of patients into one or more populations;
constructing a medication list for each patient in the population;
notifying each patient in the one or more populations of each of their own dosing events;
recording a response or non-response from each patient for each of their own dosing events;
calculating at least one medication adherence rate for the one or more populations; and
transmitting to each patient in the one or more populations, or to one or more medical professionals, a text or graphic display of the at least one medication adherence rate for the one or more populations.

13. The method of claim 12 further comprising providing each patient in the one or more populations with a plurality of dosing packets, wherein the dosing packets contain one or more medications to be taken at one dosing event by each of the patients.

14. The method of claim 13 wherein the plurality of dosing packets are connected together in a time sequence.

15. The method of claim 14 wherein the connected dosing packets are rolled and held in an outer housing.

16. A method of improving a medication adherence rate in one or more patients, comprising:
constructing a medication list, or authorizing a third party to construct a medication list for a patient, for each medication, comprising one or more of: identity of the medication, dosing frequency, dosing times, dosage amounts, medication and/or applicator depictions, dosing instructions and/or applicator instructions;
receiving a notification, at a patient's or medical professional's device, of each dosing event including the medication and dosing amount to be taken by the patient, wherein the received notification comprises at least one optional response by the patient, wherein the response indicates that the patient has taken the medication of the dosing event as notified;
transmitting to a remote location a response from the patient's or medical professional's device for each dosing event, wherein the response may indicate that the patient or medical professional has not responded to the notification;
receiving a text or graphic display of at least one medication adherence rate for the patient calculated from the number and type of responses and the number of dosing events.

17. The method of claim 16 wherein the received notification comprises at least two optional responses from the patient or medical professional, a first optional response indicating that the patient has taken the medication of the dosing event as notified and a second optional response indicating that the patient has skipped the medication of the dosing event.

18. The method of claim 16 further comprising receiving, or obtaining, a plurality of dosing packets, wherein the dosing packets contain one or more medications to be taken at one the dosing event by the patient.

19. The method of claim 18 wherein the plurality of dosing packets are connected together in a time sequence.

20. The method of claim 19 wherein the connected dosing packets are rolled and held in an outer housing.
